(19) United States
(12) Patent Application Publication
(10) Pub. No.: US 2001/0053985 A1
(43) Pub. Date: Dec. 20, 2001

(54) Intermediary methods and device for life support services

(76) Inventor: Kazuo Nakada, Kawasaki (JP)

Correspondence Address: STAAS & HALSEY, Suite 500, 700 Eleventh Street, N.W., Washington, DC, 20001, US

(21) Appl. No.: 09/746,078

(22) Filed: Dec. 26, 2000

(30) Foreign Application Priority Data
May 25, 2000 (JP) 2000-154504

(51) Int. Cl. G06F 17/60

(52) U.S. Cl. 705/3

(57) ABSTRACT

The present invention provides a method for reasonable and sensitive life support services. Meters in a customer house 1 are continuously connected to a common meter-reading center 2 by an automatic meter-reading system provided by a lifeline provider. The common meter-reading center 2 is made to have an intermediary device 2 which detects an abnormality from meter-reading results and notifies a support company, thus intermediating between the customer 1 and the support company 3. Since the intermediary device 2 is continuously connected to the meters, the meter-reading results can be frequently (e.g. once an hour) collected and analyzed. Therefore time lag between occurrence of an abnormality and detection of the abnormality can be reduced and delays in response can be prevented. By sending a list of treatments to be done from the intermediary device 2 to a PC in the customer house 1 or portable terminals of support members sent to a scene, appropriate treatments can be performed by non-professionals.

### BACKGROUND OF THE INVENTION

1. Technical Field

The present invention relates to technologies for easily constructing a life support system. More specifically, the present invention relates to technologies for easily constructing a life support system for immediately detecting and notifying emergencies such as fire, crime, or occurrence of a medical crisis, and to dispatch experts who can deal with the emergency.

2. Description of Related Art

In the present invention, a life support system means a system for extensively enhancing a safety level in one's daily life e.g. a system that checks the safety of solitary elderly people and that can be used for providing nursing care services as well as preventing and dealing with fire, crime, or occurrences of medical crises.

Various life support systems have been provided. For example, Japanese Laid-Open Pat. App. No. 11-238190 (Gazette Publication 1), Japanese Laid-Open Pat. App. No. 09-28681 (Gazette Publication 2), and Japanese Laid-Open Pat. App. No. 03-150698 (Gazette Publication 3) contain support systems for checking the safety of solitary elderly people.

The above-mentioned Gazette Publication 1 sets forth a meter-reading system that identifies abnormalities for solitary elderly people by utilizing a meter-reading system of gas meters, water meters, and sewerage meters, which are necessarily used in daily living. This system analyzes values read from a gas meter etc. at an appointed time, and if an abnormality occurs, the system notifies a care center. Above-mentioned Gazette Publication 2 sets forth a safety check system that monitors values read from an electricity meter, a gas meter, and a water meter, and notifies an abnormality to a center if the system identifies it as is the case with Gazette Publication 1. The above-mentioned Gazette Publication 3 sets forth a system that determines whether or not an abnormality occurs from the availability of water and electricity in each room.

Since the meter-reading systems set forth in above-mentioned Gazette Publications 1 to 3 determine abnormalities from variation ratio of the cumulative consumption amount of gas or water, meter-reading intervals are relatively long. That is to say, since a care center is not notified immediately after an abnormality occurs, it is likely that a solitary elderly person's problem is detected long after it occurs and when they are beyond help.

The above-mentioned Gazette Publication 2 sets forth detection of abnormalities such as upset, fever, and fainting by installing infrared sensors, etc. However, since installation of sensors is usually costly, there are a lot of people that would like to use the system but cannot.

In addition to the above-mentioned problems, there is another problem. In systems in the above-mentioned Gazette Publications 1 to 3, operators are in a sort of a support center and dispatch experts according to the situation. System providers usually do not have a network for transmitting a customer status detected by various meters and sensors to support centers. On this account, in the above-mentioned Gazette Publications 1 to 3, detected customer statuses are transmitted to support centers via a phone line, which is on an existing network. However, since phone line providers are different from the system providers set forth in Gazette Publications 1 to 3, the system providers have to pay connection fees and it is reflected in charges paid by customers to use the system.

Against this background, it is difficult to make conventional life support systems more affordable and therefore to increase the number of subscribers. It is predicted that the number of people who would like to use life support services and service providers that provide life support services will increase in the future given the aging of society and or increase in crime. However, no systems that enable service providers to provide affordable and sensitive support services have been provided yet.

### SUMMARY OF THE INVENTION

The object of the present invention is to provide systems that notify statuses of customers to life support service providers and thus to provide technologies to enable affordable and sensitive life support services.

To solve the above-mentioned problems, a first aspect of the present invention provides an intermediary method of life support service which intermediates between customer groups and at least one of the life support service providers and includes:

A: collecting, from a customer's house via a network, a detection result that one of predetermined statuses is detected directly or indirectly;

B: analyzing said detection result and determining whether or not a customer status is abnormal; and

C: notifying an unusual situation to any of the providers if the above-mentioned customer status is abnormal.

Automatic meter-reading systems which automatically read water, gas, and electricity meters and transmit the result to a meter-reading center via a network including the Internet have already been provided. The intermediary system in the present invention avails of mechanism provided by the automatic meter-reading system. By analyzing meter information collected by the automatic meter-reading system, whether a customer status is abnormal can be estimated in a conventional method alike. Since meters are continuously connected to a meter-reading center in this system, information from the meters can be collected at the meter-reading center and thus any time lag between the occurrence of an abnormality and the detection of the abnormality can be dramatically reduced.

Various sensors other than water, gas and electricity meters can be used as a detection method. By connecting more sensors to a network gateway provided for each home by the automatic detection system, custom statuses can be detected from various aspects and an accurate life support service can be implemented.

The number of affiliates to an automatic meter-reading system which is directly connected to lifelines is incomparably more than that of affiliates to conventional life support systems. Network wiring to connect houses of customers to a meter-reading center, Internet gateways which connect the network to the Internet, and Internet providers are provided by lifeline providers. On this account, the providers of life support services do not need to invest in the construction of a system for collecting and analyzing detected customer statuses and can provide affordable and sensitive services. This means the reduction of service charges and improvement of services for customers.

A second aspect of the present invention is an intermediary system of life support services which intermediates between customer groups and at least one of the life support service providers. This system comprises a detection means, a network gateway, a collection means, a determination means, and a notification means.

The detection means detects customer statuses directly or indirectly. The network gateway is installed in the above-mentioned customer's house and connects the above-mentioned detection means and a network. The collection means collects detection results from the above-mentioned detection means via a network. The determination means analyzes the collected detection result and determines whether or not a customer status is abnormal. The notification means notifies an unusual situation to any of the above-mentioned providers if the above-mentioned customer status is abnormal.

This system has a configuration which realizes the intermediary system in the above-mentioned first aspect of the present invention.

A third aspect of the present invention provides an intermediary device used for the life support service which intermediates between customer groups and at least one of the life support service providers. This device has a customer database, the collection means, the determination means, and the notification means.

The customer database stores information on customers and life support service providers with which the customers contract. The collection means collects detection results that predetermined customer statuses are detected via a network. The determination means analyzes the collected detection results and determines whether or not a customer's status is abnormal. The notification means refers to the above-mentioned customer database and notifies an unusual situation to any of the above-mentioned providers contracting with a customer in an unusual situation if the above-mentioned customer status is abnormal.

This intermediary device intermediates between multiple customers and multiple life support service providers. Customers selectively contract with life support service providers and pay the service providers charges. Contracting between customers and life support service providers and payment of the charges may be performed via an intermediary agency. If an unusual situation occurs, the service provider is notified that a customer under contract thereto is in an unusual situation. Normally, the intermediary device is installed in a sort of a support center, and notifies the unusual situation to resident operators. Operators notify the unusual situation to a service provider after confirmation by phone call, and then request support members to go into treatment.

A fourth aspect of the present invention provides, in an intermediary device used for the third aspect of the present invention, the above-mentioned customer database storing service contents for which customers contract in addition to customers and life support service providers contracting with customers. Moreover, in this device, if the above-mentioned custom status is abnormal, the notification means decides whether to notify an unusual situation to the above-mentioned provider by referring to the above-mentioned service contents, and notifies the unusual situation to the above-mentioned provider with which the customer in the unusual situation contracts according to the above-mentioned decision.

Customers selectively contract with life support service providers, select necessary services, and pay the service providers charges. Contract between customers and life support service providers and payment of the charges may be performed via an intermediary agency. If an unusual situation occurs to a customer, it is notified to the service provider contracting with the customer according to contents of the contract.

A fifth aspect of the present invention provides, in the third aspect of the present invention, an intermediary device used for life support services further comprising a treatment database and an on-the-scene administration means.

The treatment database stores conditions of unusual situations and treatments to be performed for an occurred condition. The on-the-scene administration means determines a treatment to be performed by referring to the above-mentioned treatment database if an unusual situation occurs, and provides a list of the above-mentioned treatments to the above-mentioned life support service provider via a network.

As an example of a notification means via a network, placing treatments to be performed on each web page of life support service providers can be performed. Service providers sent to a scene access the web page with, for example, portable terminals and promptly confirm treatments to be performed.

A sixth aspect of the present invention provides, in the fifth aspect of the present invention, an intermediary device used for life support further having a reception database for storing information on customers, unusual situations occurred, and treatments in response to the unusual situations. The above-mentioned on-the-scene administration means receives the selection of a treatment from the above-mentioned treatment list, and writes the unusual situation and selected treatment in the above-mentioned reception database.

The reception database integrally administrates treatments which are performed for unusual situations from the occurrence of those unusual situations.

A seventh aspect of the present invention provides, in the fifth aspect of the present invention, an intermediary device used for life support, wherein said treatment database hierarchically stores options for anticipatory situations, and treatments to be performed for each situation. In the intermediary device, the above-mentioned on-the-scene administration means creates a list of situations which are anticipated based on performed treatment, and a list of treatments corresponding to a selected situation based on the treatment database. The intermediary device then notifies the lists to the above-mentioned life support service provider via a network.

When support members sent to a scene select an applicable situation from the list of situations, treatments suitable to the situation are provided. Accordingly, appropriate treatments can be performed unless the situation is exceptionally difficult to handle. For example, support members other than doctors or nurses can perform appropriate emergency medical treatments. The situation and treatments are stored in the reception database. Therefore transition of the situation and treatments performed in an unusual situation can be traced later.

An eighth aspect of the present invention provides a computer-readable storage medium storing an intermediary program of life support services used in an intermediary device. The intermediate device intermediates between customer groups and at least one of the life support service providers. The above-mentioned intermediary program executes the following steps A to D:

A: a step of preparing a customer table which stores customers and life support service providers with which the customers contract;

B: a step of collecting via a network detection results that predetermined customer statuses are detected;

C: a step of determining whether or not the customer status is abnormal by analyzing the collected detection results; and

D: a step of notifying an unusual situation to the above-mentioned providers contracted by the customer in the unusual situation if the above-mentioned customer status is abnormal, based on the customer table.

The eighth aspect of the present invention has the same effect as the third aspect of the present invention.

### BRIEF DESCRIPTION OF THE DRAWINGS

FIG. 1 is a conceptual diagram 1 of a solitary elderly people status checking system according to a first embodiment of the present invention.

FIG. 2 is conceptual diagram 2 of a solitary elderly people status checking system according to a first embodiment of the present invention.

FIG. 3 is an overall configuration diagram of a solitary elderly people status checking system according to the first embodiment of the present invention.

FIG. 4 is a conceptual explanatory diagram of information stored in the customer database according to the first embodiment of the present invention.

FIG. 5 is a conceptual explanatory diagram of information stored in the treatment database according to the first embodiment of the present invention.

FIG. 6 is a conceptual explanatory diagram of information stored in the reception database according to the first embodiment of the present invention.

FIG. 7 is an explanatory diagram of flow of process in the overall system according to the first embodiment of the present invention.

FIG. 8 is a flowchart showing flow of process performed by the intermediary device according to the first embodiment of the present invention.

FIG. 9 is a display example of lists displayed on a customer's PC or portable terminals of support members according to the first embodiment of the present invention.

FIG. 10 is an overall configuration diagram of a solitary elderly people status checking system according to a second embodiment of the present invention.

### DETAILED DESCRIPTION OF THE PREFERRED EMBODIMENTS

[Outline of the Invention]

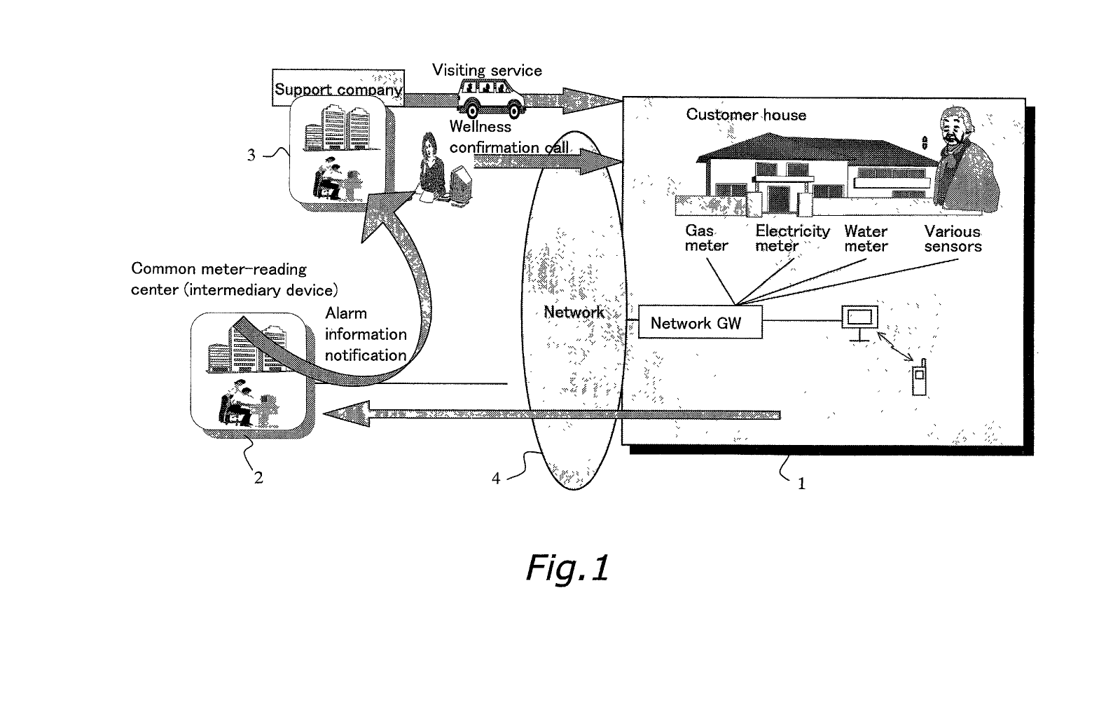

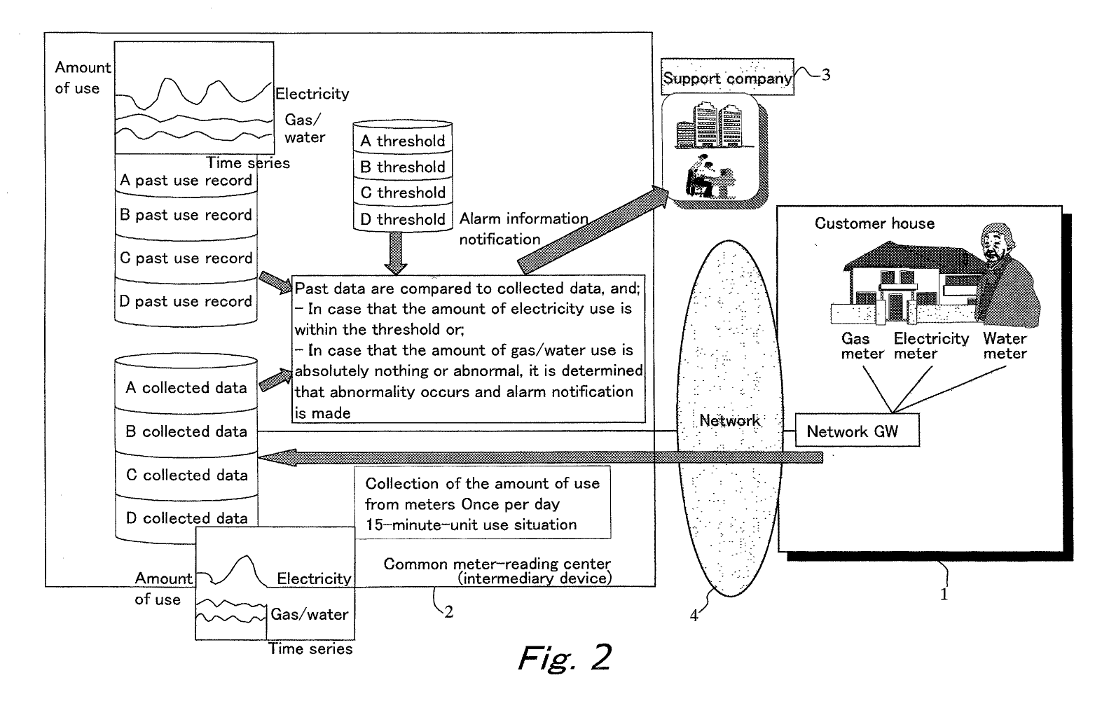

FIG. 1 and FIG. 2 are overall conceptual diagrams of a solitary elderly people status checking system realized by applying the intermediary method of life support services in the present invention. In this system, a customer house 1, a common meter-reading center 2, and a support company 3 are connected via a network 4. In the customer house 1, at least a gas, electricity or water meter is installed. The result of the meter reading is sent to the common meter-reading center 2. As shown in FIG. 2, records of gas, electricity and water use for each customer are stored in the common meter-reading center 2. An intermediary device installed in the common meter-reading center 2 determines if the current result is abnormal based on the use record by comparing the meter-reading result to previous results. If the intermediary device determines that the result is abnormal, it requests the support company 3 to go into treatment.

In this system, meters for the customer house 1 are continuously connected to the common meter-reading center 2 by an automatic meter-reading system provided by lifeline providers of gas, electricity, and water. Accordingly, if the common meter-reading center is given a intermediary device 2 which detects an abnormality from a collected result of the meters and notifies the support company 3, intermediating between the customer 1 and the support company 3 can be easily performed. Since the intermediary device is continuously connected to meters, meter-reading results can be frequently, for example, once an hour, collected and analyzed. Accordingly, time lag between occurrence of an abnormality and detection of the abnormality can be reduced and delays in response time can be prevented.

Furthermore, by sending a list of treatments to be done from the intermediary device 2 to a computer in the customer house 1 or portable terminals of support members sent to a scene, appropriate treatments can be performed by non-professionals.

Thus, using the intermediary method of life support services in the present invention eliminates the need for constructing a new system to notify custom statuses detected in the customer house 1 to the support company 3, and notification of the abnormality of the customer status to the support company 3 is enabled through only by analyzing the analysis of the customer status collected by the automatic meter-reading system. The custom status can be collected from the detection result of various sensors as well as lifeline meters. Therefore the support company 3 can provide affordable and sensitive life support services for the customers without investing in the construction of a system for collecting the custom status.

First Embodiment

[Overall configuration]

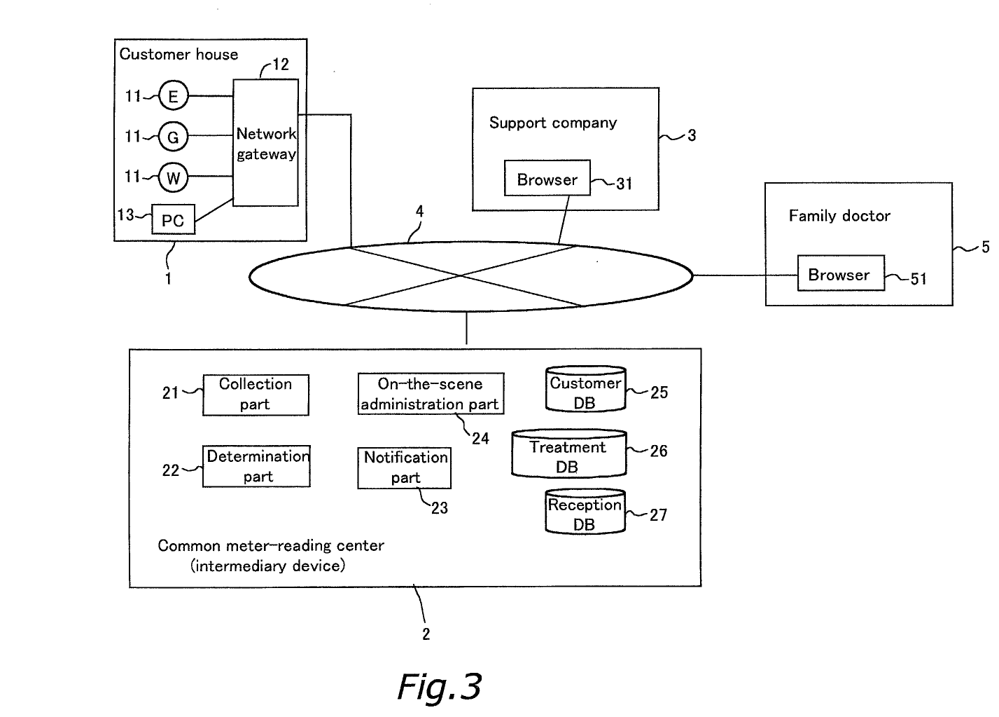

The following specifically explains a solitary elderly people status checking system. FIG. 3 is an overall configuration diagram of the solitary elderly people status checking system as determined in the first embodiment. This system is configured by connecting the customer house 1, the intermediary device 2, the support company 3, and a family doctor 5 via the network 4 including the Internet. In the intermediary device 2, a collection part 2, a determination part 22, a notification part 23, on-the-scene administration part 24, and three databases 25 to 27 are installed. However, all of them may be concentrated on a single computer or dispersively mounted on several computers depending on the performance of the computers.

In the customer house 1, gas (G), electricity (E), and/or water (W) meters 11 are installed and the meter-reading result is transmitted on a network via a network gateway 12. In the customer house, a personal computer (PC) 13 is also installed and is connected to the network 4 via the gateway 12. Meters of lifelines, various sensors, and a PC 13 are continuously connected from the network gateway 12 to the Internet via optical cables provided by lifeline providers, an Internet gateway, and an Internet provider.

A meter-reading result is collected by the collection part 21 of the intermediary device 2, and the determination part 22 determines whether or not an unusual situation occurs. When an unusual situation occurs, the unusual situation occurred is stored in the reception database (DB) 27. If treatments of the support company 3 are needed, the notification part 23 requests the support company to go into treatment. The support company 3 regularly monitors with a browser 31 whether or not an unusual status occurs to the customer. If the intermediary system requests treatment, the support company sends support members to the scene. Support members sent to the scene report their arrival at the scene, treatments done for the customer, completion of the treatments, etc. These reports are received by an on-the-scene administration part 24 of the intermediary device 2 and are stored in the reception DB 27.

Contents of treatments for a customer differ depending on the contents of the contract between the customer and a support company, the situation, and the transition of the situation. The on-the-scene administration part 24 refers to a customer DB 25 and an treatment DB 26, and sends a list of treatments to be performed by support members sent to the scene and a status list of a customer to the PC 13 and portable terminals. Support members can easily report the situation and treatments performed by selecting a situation or a treatment from the lists. For example, this enables support members other than nurses or doctors to take emergency medical treatments to some extent. The intermediary device 2 can automatically store the transition of the situation by receiving the selected situation and treatment and storing them in the reception DB 27.

Furthermore, according to the contract between a customer and a support company, an unusual status of a customer can be notified to a family doctor and support members can be directed by the family doctor 5. The family doctor 5 can regularly monitor the status of his patient in his house with the browser 51 and direct appropriate treatments.

[Database]

Customer DB

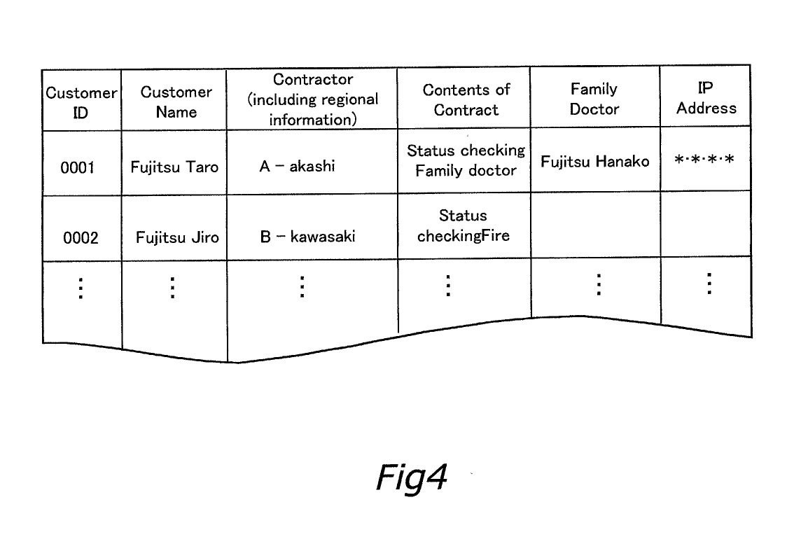

FIG. 4 is a conceptual explanatory diagram of information stored in the customer DB 25. Customer IDs, customer names, contractors (including regional information) contents of the contracts, family doctors, and IP addresses are stored in the customer DB.

In Customer ID and Customer Name, identification information to identify uniquely each customer and the name of the customer are respectively described.

In Contractor, a support company 3 with which the customer contracts is described. The support company 3 provides various life support services and can be more than one company. The support company 3 has nationwide support centers in every region, and sends support members to each customer house. The support company 3 determines a support center in charge of the customer when the company contracts with the customer. Accordingly, in Contractor, regional information is also described to identify which support center is in charge of the customer. In FIG. 4, A and B are names of support companies and “akashi” and “kawasaki” are regional information.

In Contents of Contract, life support services provided for the customer by the support company according to the contract are described. Contents of a contract are not necessarily unique. For example, in this figure, Fujitsu Taro contracts for the status checking service and the family doctor service provided by a support company A. Meanwhile, Fujitsu Jiro contracts for the status checking system and fire detection service provided by the support company B. Incidentally, the family doctor service means a 24-hour monitoring service by the above-mentioned family doctor.

In Family Doctor, a name of a customer's family doctor is described. In IP Address, the IP address of a family doctor's computer is described. If the customer contracts for the 24-hour monitoring service by the family doctor, the name of the family doctor and his IP address are described in the customer DB, and occurrence of an unusual situation to the customer is notified to the family doctor. Incidentally, it goes without saying that the address is not limited to an IP address, and another address is available as long as it is identifiable as the address of the customer's computer.

Treatment DB

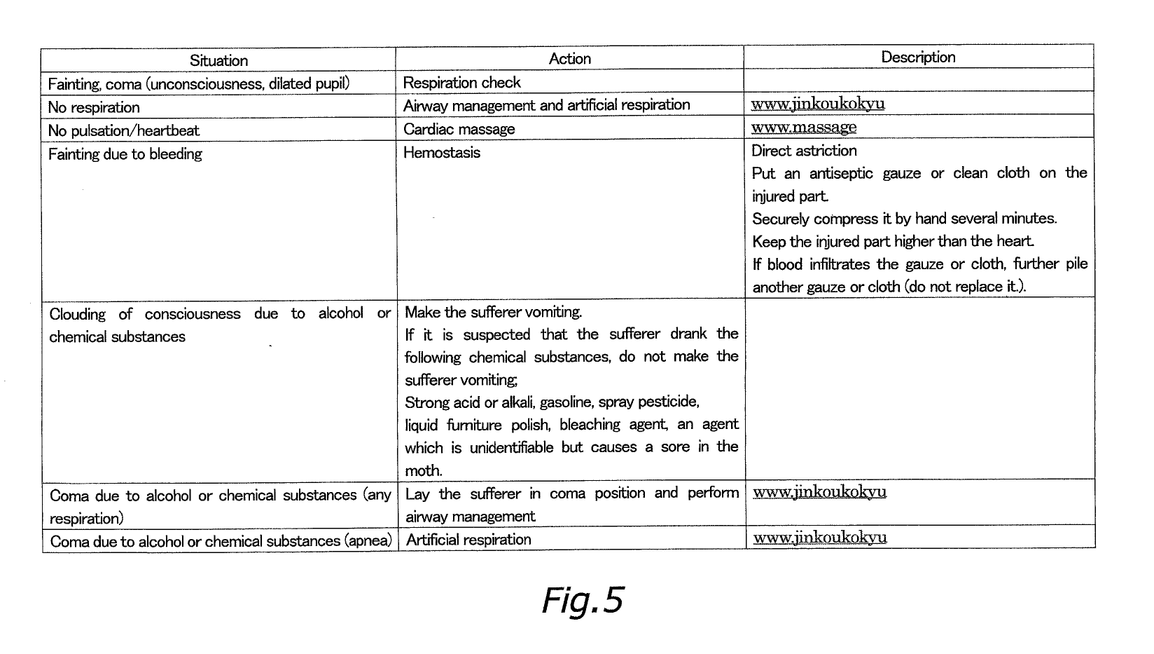

FIG. 5 is a conceptual explanatory diagram of information stored in the treatment DB 26. In the treatment DB, condition of an unusual situation, treatments to be performed according to the situation, and description of the treatments are stored. Explanatory texts in character data, or image data showing treatment method can be stored in the treatment DB as descriptions. Address of data can be also stored instead of data itself. For example, in this figure, image data and character data showing methods of artificial respiration are stored in an address indicated by www.jinkoukokyu. Data showing methods of cardiac massage are stored in an address indicated by www.massage.

By databasing situations and treatments in the above-mentioned way, situation lists and treatment lists can be presented to support members, and transition of an unusual situation can be automatically input into the DB. By storing descriptions of treatment methods in the treatment DB, support members can take appropriate emergency treatment even if they do not have expertise on situations, and allowing situations to progress to where the customer is beyond treatment can be prevented.

Reception DB

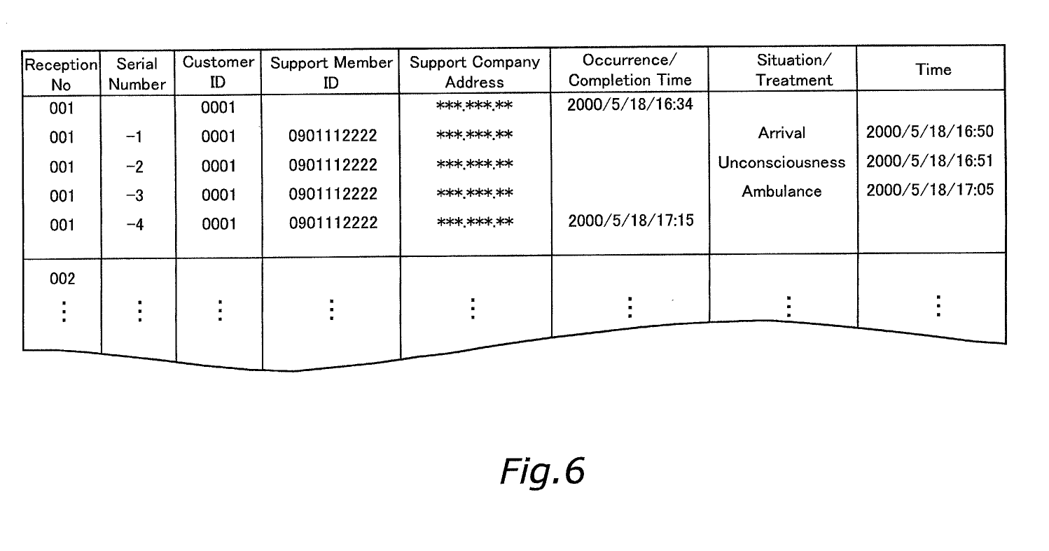

FIG. 6 is a conceptual explanatory diagram of information stored in the reception DB 27. The reception DB stores Reception No., Serial Number, Customer ID, Support Member ID, Support Company Address, Occurrence/Completion Time, Situation/Treatment, and Time. In Reception No., an identification number for uniquely identifying an unusual situation which occurred in a customer's house is described.

In Serial Number, a serial number starting at 1 is described as a situation of an incident undergoes a transition. In Customer ID, any one of the customer ID is stored in the above-mentioned customer DB. In Support Member ID, an ID showing a support member that a support company sends to a scene e.g. the number of a portable terminal is described.

In Support Company Address, an IP address which is a contact address of a support company with which the customer contracts is described. Specifically, it is an IP address of a computer installed in a support center for supporting the customer.

In Occurrence/Completion Time, first detection time of an abnormal situation or time when a support member reports completion of treatments is described.

In Situation/Treatment, a customer's situation reported from support members sent to a scene and treatments performed by the support members are described. In Time, the time when a situation described in Situation/Treatment changes or treatments is performed.

[Process flow]

Overall process flow

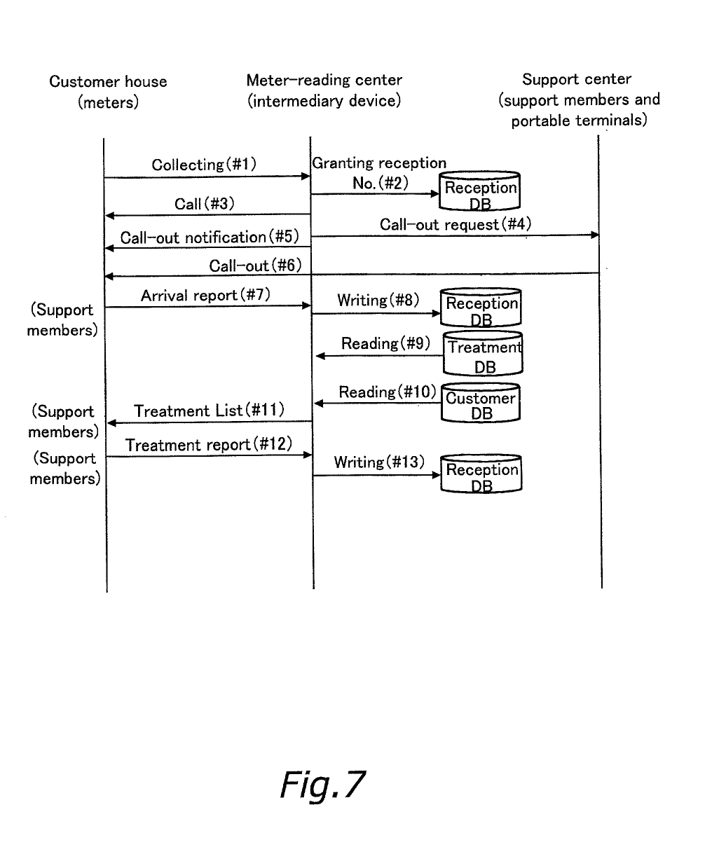

FIG. 7 is an explanatory diagram showing process flow in the overall system in the first embodiment. Meter-reading results from the meter 11 installed in the customer houses 1 are collected by the intermediary device installed in the common meter-reading center (#1). The meter-reading center determines whether an unusual situation has occurred to the customers by referring to the use record. For example, if the amount of water use, which will be necessarily used as long as the customer is alive, does not change, it is determined that the customer is immotile. As an analyzing method of meter-reading results, publicly-known various methods can be used. It is preferable that meter-reading results are collected as frequently and usefully as possible so that an unusual status can be immediately detected.

If an abnormality is detected as a result of the collection and analysis, the intermediary device 2 grants the unusual situation a reception No (#2). In this step, the reception No., the customer ID, and occurrence time are written in the reception DB 27. Resident operators contact the customer house 1, for example, by telephone (#3). If the contact does not result in a normal response, the intermediary device 2 requests the support company 3 with which the customer contracts to go into treatment by the operator's operation. Specifically, the occurrence of the unusual situation is notified to the support center covering the region where the customer house 1 exists. The intermediary device 2 notifies a PC 3 installed in the customer house 1 that the support company is taking into action (#5).

Receiving the above-mentioned notification, the support center 3 sends support members to the scene (#6). Support members take portable terminals when they go into treatment. Support members who arrived on the scene send an arrival report to the intermediary device 2 with the portable terminals or the PO 13 in the customer house 1 (#7). The intermediary device 2 receiving the report writes the arrival report and the report time in the reception DB 27 (#8).

The intermediary device 2 refers to the treatment DB and the customer DB 25, and sends a list of menus of treatments to be performed against the customer in an unusual situation to the portable terminal 2 or the PC 13 in the customer house 1 (#9, #10, and #11). The support members select a treatment from the treatment list, execute the treatment, and report the executed treatment selected from the list (#12). The reported treatment is written in the reception DB by the intermediary device 2 (#13).

As mentioned above, the intermediary device 2 intermediates between the support company 3 sending support members and supporting the customer's life and the customer via a network. Customers and support company are nonspecific and optional. Therefore, the customer 1 who intends to avail services and the support company 3 which intends to provide services can attain the intentions via the intermediary device 2.

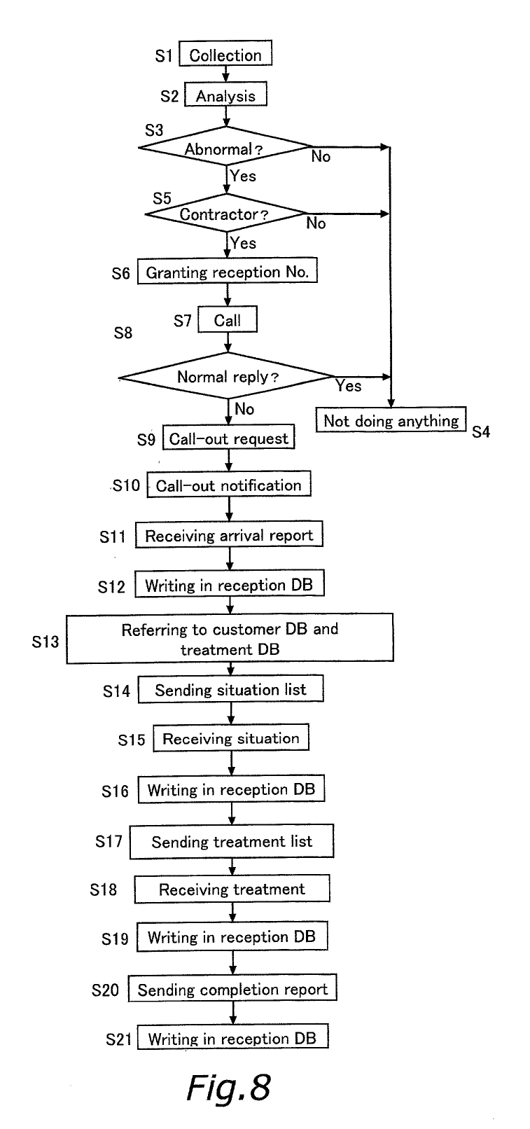

Process flow performed by the intermediary device FIG. 8 is a flowchart showing detailed process flow performed by the intermediary device.

Step S1: The intermediary device 2 collects a meter-reading result from meters in the customer house 1. The collection is performed on enough intervals to detect abnormalities e.g. once an hour or once per quarter hour.

Step S2: The intermediary device 2 analyzes the detection result for each customer based on past data.

Step S3: The intermediary device 2 determines whether or not an unusual situation has occurred and if the result is not abnormal step S4 ensues. That is to say, if no unusual situations exist, nothing is done. If an unusual situation has occurred, step S5 ensues.

Step S5: The intermediary device 2 determines whether or not the customer in an unusual situation is a customer with which the company contracts. This determination is performed by looking up in the customer DB 25 based on the identification number of a network gateway in the customer house 1 such as an IP address. If the result is “No,” nothing is done because the customer does not contract with it (step 4). If the customer contracts with the company, step S6 ensues.

Step S6: The intermediary grants an unusual situation a reception No. and writes the reception No., the IP address of the support center, customer ID, and occurrence time in the reception DB 27.

Step S7: The intermediary device 2 tries to contact the customer house 1 by phone, for example. Specifically, the intermediary device 2 calls the customer house. Operator's selection of the customer displayed on the display screen of the intermediary device 2 may make an automatic call.

Step S8: The intermediary device 2 determines whether or not the call results in a normal response based on the operator's operation. If the result is normal, nothing is done (step S4). If response is not normal, for example, there is no response or although there is responses it is unordinary, step S9 ensues.

Step S9: Referring to the customer DB 25, the intermediary device 2 notifies the occurrence of an abnormal situation to the support center 3 of the support company with which the customer contracts and requests treatment. For example, the intermediary device 2 sends a warning screen or a warning sound to a webpage the browser 31 of the support center 3 to which it refers. Incidentally, the browser 31 of the support center 3 regularly monitors its webpage provided by the intermediary device 2, and if an abnormality occurs, it is notified via the webpage.

In response to the above-mentioned request, the support center 3 selects support members based on the support DB (not shown in the figure) and notifies information for identifying support members i.e. member Ids to the intermediary device 2. The support DB is a database which administrates members of the support center 3, and stores basic information such as names, basic support region, supported skills, and operation situation such as Going into treatment/In operation together with the identification information of the members.

Step S10: The intermediary device 2 notifies the PC 13 in the customer house that it requests the support center to go into treatment. In response, the PC 13 in the customer house waits for call-out of the support members.

Step S11: The intermediary device 2 receives an arrival report from support members who arrived at a scene. For example, the PC 13 which waits for support members to arrive detects their potable terminals through a radio technology such as infrared data communication or Bluetooth. Thus, the arrival report is automatically sent to the intermediary device 2. The support members may send an arrival report by operating the PC 13 or portable terminals.

Step S12: The intermediary device 2 records the arrival of support members and time in the reception DB. Step S13: Referring to the customer DB 25 and treatment DB 26, the intermediary device 2 determines treatments to be performed for the customer in the unusual situation. For example, for a customer who contracts only for status checking service, his family doctor is not notified of an unusual status.

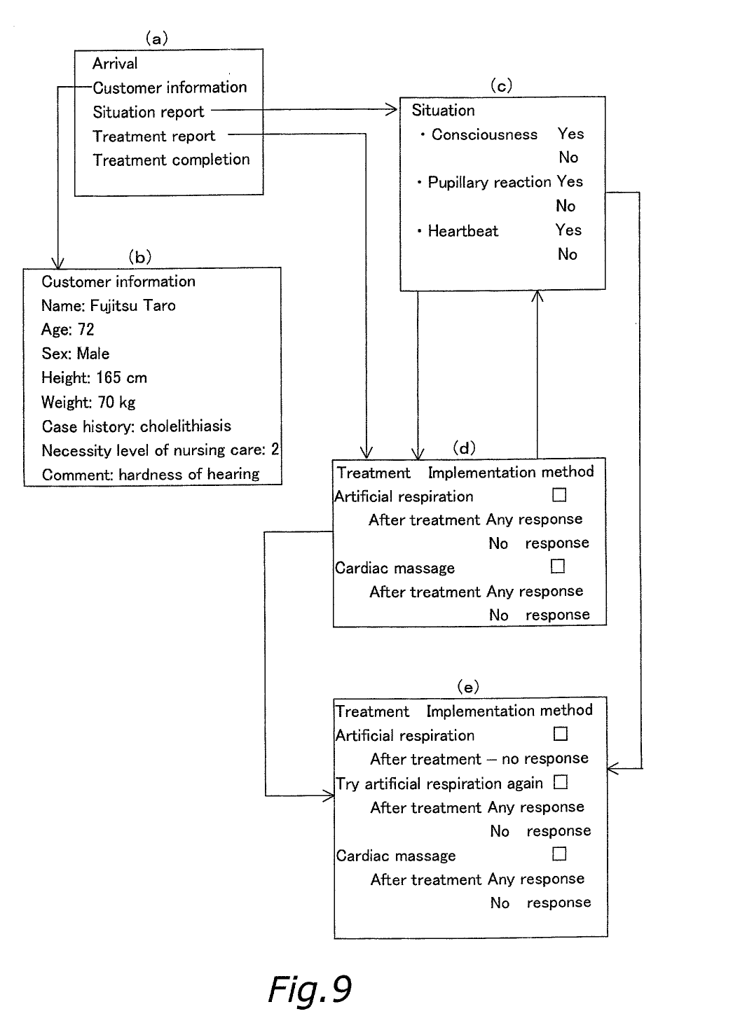

Step S14: The intermediary device 2 sends a list of situations anticipated from the firstly-detected unusual situation to the portable terminals of the support members and the PC 13 in the customer house. By selecting a corresponding situation on the list, the support members can send a condition report from the portable terminals and the PC 13 to the intermediary device 2. The list of situations is presented by accessing a dedicated webpage which has been previously prepared for each portable terminal and each customer. Fig. 9 is a display example of a situation list displayed on the PC 13 and portable terminals. A detailed description concerning FIG. 9 will be given later.

Steps S15 and S16: The intermediary device 2 receives a situation selected from the send situation list and writes the received situation and its reception time in the reception DB 27. A serial number is also assigned and written in the reception DB 27.

Step S17: The intermediary device 2 reads a list of treatments suitable to the selected situation from the treatment DB and sends the treatment list to portable terminals of the support members and the PC 13 in the customer house. FIG. 9 shows an example of a treatment list displayed on the portable terminal and the PC 13. A detailed description concerning FIG. 9 will be given later.

Steps S18 and S19: The intermediary device 2 receives any treatment selected from the sent treatment list and writes it with the serial number in the reception DB 27. Steps S20 and S21: The intermediary device 2 sends situation lists and treatment list one after another until it receives a completion report or no optional treatments are left. When it receives a completion report, it writes the report with the reception time in the reception DB 27.

As described above, occurrence of an unusual situation, transition of a condition, and treatments performed are stored in the reception DB 27 by the intermediary device 2. The transition of conditions of the situation occurred and treatments performed are integrally administrated. By this means, when support company B takes over the administration from support company A, support company A can fully report what situation and treatment performed have brought a customer to the current situation. This is useful when more than one support company with different expertise support the life of a customer.

For example, a hospital (support company B) can take over administration of a situation from a nurse who is a support member of support company A because the situation becomes critical, although the nurse initially deals with a situation. In this case, a support member of the hospital (doctor) can perform the most appropriate treatment because he can comprehend exactly transition of a situation from occurrence of the situation to the takeover and treatments performed by the nurse.

[Screen example]

FIG. 9 is an example of a list screen displayed on the PC 13 in the customer house, portable terminals of support members, etc. FIG. 9 (a) is a dedicated homepage for the PC 13 and portable terminals. In this homepage a support member selects “Arrive”. An arrival report is sent to the intermediary device 2. When “Customer Information” is selected, information read from the customer DB is displayed as shown in FIG. 9 (b).

When “Status Report” is selected, a list of anticipatory situations is displayed as shown in FIG. 9 (c). When any of the situations is selected from the list or “Treatment Report” is selected in the homepage, treatments to be performed in response to the situation are displayed. These treatments are displayed in order of priority, for example. When “Treatment Method” is clicked in the list, the description of a method of a treatment is displayed. This description is stored in the above-mentioned treatment DB. When a retreatment to the treatment is selected, further optional treatments to be performed are displayed as shown in FIG. 9 (e) after a list of anticipatory situations is displayed as shown in Fig.9 (c) or immediately after the retreatment is selected.

A treatment list shown in FIG. 9 (e) is displayed so that treatments which have been already done are visually distinctive from treatments which have not been done. In this figure, a treatment which is already done “Artificial respiration” is hatched. Meanwhile, the most recommended treatment which has not been done is emphatically displayed by red display, boldface display, etc.

Selecting “Treatment Completed” on the homepage after all treatments which can be done are completed sends a completion report to the intermediary device.

Second Embodiment

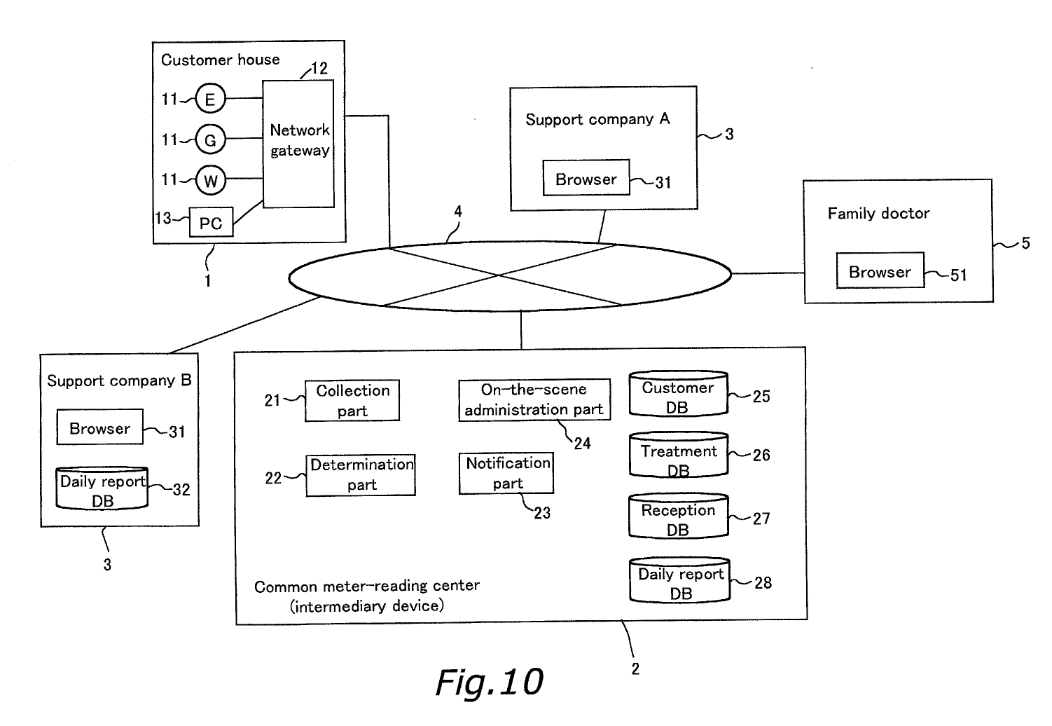

FIG. 10 is an overall configuration diagram of a solitary elderly people status checking system in accordance with the second embodiment. This system can provide nursing services as well as status checks for the above-mentioned solitary elderly people. The second embodiment differs from the first embodiment in that the intermediary device 2 has a daily report DB 28 and there are several support companies A and B. A browser 31 is provided for the support company A as is the case with the first embodiment. The daily report DB 32 in addition to the browser is provided for the other support company B.

If the common meter-reading center 2 is substantially the same organization as the support center 3, the intermediary device 2 can be made to have the daily report DB and can automatically update the daily report DB as is the case with the above-mentioned reception DB 27. However, the treatment DB must be made to have a list of nursing care within coverage for nursing care to automatically update the daily report DB. When a nursing service within the coverage of nursing care is performed, the intermediary device 2 writes data to the daily report DB 28.

Meanwhile, if the support company B providing nursing care service is substantially the same organization as the common meter-reading center, the daily report DB 32 must be installed in the support company B. The daily report DB 32 of the support company B is updated by the system of the support company B.

Another Embodiment

In the above-mentioned embodiment, status check of solitary elderly people and nursing care services are listed as life support services; however, methods of the present invention are applicable to extensive life support services such as fire detection, crime detection, and detection of occurrence of medical crises. Specifically, preparing for variation of unusual situations to be detected according to installation of various sensors for detecting a customer's situation such as sensors for detecting heat and smoke, infrared sensors or impact sensors installed on windows for detecting an intruder, and various vital sensors for sensing statuses of living bodies enables statuses of a customer in daily life to be collected from various aspects. Notifying various unusual statuses collected to service providers enables accurate life support services to be mediated.

It is conceivable that the PC 13 in the customer house 1 is not turned on. If this is the case, the IP address of the PC 13 in the customer house 1 changes every time the PC is turned on. For this reason, the intermediary device 2 is made to have a correspondence table between IP addresses and customers. If an unusual situation occurs, the PC 13 is turned on by calling the PC 13 from the intermediary device 2. Incidentally, a device for activating the PC 13 by a call from outside is previously installed in the PC 13. A provider of the intermediary device 2 can also be an Internet service provider which grants the PC 13 an IP address and activates the PC 13 reports on an IP address granted by the Internet service provider to the intermediary device 2. Hereafter the intermediary device 2 sends a treatment list to a reported IP address.

In the above-mentioned embodiment, contents of treatments set in the treatment DB are general-purpose. However, contents of treatments for each customer and his situation may be stored in the treatment DB. This is because treatments for the same symptom differ due to various individual factors such as chronic illness and constitution of a customer. If this is the case, it is also conceivable that history of treatment, case history, history of prescribed medicine, etc. of a customer can be stored in the treatment DB or customer DB. Storing such information enables more sensitive treatments according to a customer's needs as well as tracking general treatment that needs to be done when considering a customer's unusual situation.

A recording medium recording a program for executing the above-mentioned methods of the present invention is included in the present invention. Herein a computer-recordable medium can be a floppy disk, hard disk, semiconductor memory, CD-ROM, DVD, MO, etc.

Use of the present invention allows collection and analysis of the customer's statuses from various aspects and thus enables reasonable and sensitive services to be provided for customers without constructing systems for collecting and analyzing customer's statuses.

While only selected embodiments have been chosen to illustrate the present invention, to those skilled in the art it will be apparent from this disclosure that various changes and modifications can be made herein without departing from the scope of the invention as defined in the appended claims. Furthermore, the foregoing description of the embodiments set forth in the present invention is provided for illustration only, and not for the purpose of limiting the invention as defined by the appended claims and their equivalents.

What is claimed is:

1. An intermediary method of life support services which intermediates between customer groups and at least one of the life support service providers, comprising:
collecting, from a customer's house via a network, a detection result that one of predetermined statuses is detected directly or indirectly;
analyzing said detection result and determining whether or not a customer status is abnormal; and
notifying an unusual situation to any of said providers if said customer status is abnormal.

2. An intermediary system of life support services which intermediates between customer groups and at least one of the life support service providers, comprising:
a detection means for detecting customer statuses directly or indirectly;
a network gateway for being installed in said customer's house and connecting said detection means and a network;
a collection means for collecting detection results from said detection means via the network;
a determination means for analyzing the collected detection result and determining whether or not a customer status is abnormal; and
a notification means for notifying an unusual situation to any of said providers if said customer status is abnormal.

3. An intermediary device used for life support services for intermediating between customer groups and at least one of the life support service providers, comprising:
a customer database for storing customers and life support service providers with which the customers contract;
a collection means for collecting detection results that predetermined customer statuses are detected via a network;
a determination means for analyzing the collected detection results and determines whether or not a customer status is abnormal; and
a notification means for notifying an unusual situation to any of said providers if said customer status is abnormal.

4. An intermediary device used for life support services set forth in claim 3, wherein
said customer database further stores service contents to which customers contract in addition to customers and life support service providers contracting with the customers, and if said custom status is abnormal, the notification means decides whether to notify an unusual situation to said provider by referring to said service contents, and notifies the unusual situation to said provider contracting with the customer in the unusual situation according to said decision.

5. An intermediary device used for life support services set forth in claim 3, further comprising:
a treatment database for storing conditions of unusual situations and treatments to be performed for an occurred condition; and
an on-the-scene administration means for determining treatment to be performed by referring to said treatment database if an unusual situation occurs, and provides a list of said treatments to said life support service provider via a network.

6. An intermediary device used for life support services set forth in claim 5 further having a reception database for storing customers, unusual situations occurred, and treatments against the unusual situations, wherein
said on-the-scene administration means receives the selection of a treatment from said treatment list, and writes an unusual situation and selected treatment in said reception database.

7. An intermediary device used for life support services set forth in claim 5, wherein
said treatment database hierarchically stores options for anticipatory situations, and treatments to be performed for each situation; and
said on-the-scene administration means further creates a list of situations which are anticipated based on performed treatments, and a list of treatments corresponding to a selected situation based on said treatment database, and notifies said life support service provider via a network.

8. A computer-readable storage medium on which an intermediary program for life support services is recorded for use in an intermediary device which intermediates between customer groups and at least one of the life support service providers, the computer-readable storage medium wherein is recorded an intermediary program for executing;
A: a step of preparing a customer table which stores customers and life support service providers with which the customers contract;
B: a step of collecting via a network detection results that predetermined customer statuses are detected;
C: a step of determining whether or not the customer status is abnormal by analyzing the collected detection results; and
D: a step of notifying, based on the customer table, an unusual situation to said providers contracted by the customer in the unusual situation if said customer status is abnormal.
